(19) United States
(12) Patent Application Publication
(10) Pub. No.: US 2023/0284594 A1
(43) Pub. Date: Sep. 14, 2023

(54) HANDS-FREE LEASH

(71) Applicant: Denis Tyrrell, Ft. Pierce, FL (US)

(72) Inventor: Denis Tyrrell, Ft. Pierce, FL (US)

(21) Appl. No.: 18/104,551

(22) Filed: Feb. 1, 2023

Related U.S. Application Data
(60) Provisional application No. 63/319,422, filed on Mar. 14, 2022.

(51) Int. Cl. A01K 27/00

(52) U.S. Cl. CPC A01K 27/004

(57) ABSTRACT

A hands-free leash, including a wrist connecting cord, including a cord body, a wrist connector disposed on at least a portion of a first end of the cord body to removably connect to at least a portion of a limb of a user, and a cord unit connector disposed on at least a portion of a second end of the cord body, and a retractable cord unit connected to the cord unit connector to connect the cord body to a harness of a pet.

### CROSS-REFERENCE TO RELATED APPLICATIONS

This application claims priority under 35 USC § 120 from U.S. Provisional Application No. 63/319,422, entitled “Hands-Free Leash,” which was filed on Mar. 14, 2022, in the United States Patent and Trademark Office, the disclosure of which is incorporated herein in its entirety by reference.

### BACKGROUND

### 1. Field

The present general inventive concept relates generally to a leash, and particularly, to a hands-free leash.

### 2. Description of the Related Art

While walking a pet, it can difficult to multi-task especially if an external distraction (e.g., a person, an animal, a sound, etc.) and/or personal needs conflict with maintaining a firm grip of a leash on the pet. Many owners of dogs are aware of the dog's tendency to naturally tug and/or pull while walking. Moreover, the sudden loss of grip and/or release of the leash can create a very stressful and potentially dangerous situation for both the pet and an owner when in public spaces.

Many leashes used by the owners rely on the firm grip by a hand of the owner. Therefore, the owner can rarely ignore the necessity of keeping the grip stable while walking the pet, unless the owner voluntarily releases the grip, such as at a dog park.

Therefore, there is a need for a hands-free leash that does not require constant monitoring of the owner to prevent the pet from leaving the owner.

### SUMMARY

The present general inventive concept provides a hands-free leash.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hands-free leash, including a wrist connecting cord, including a cord body, a wrist connector disposed on at least a portion of a first end of the cord body to removably connect to at least a portion of a limb of a user, and a cord unit connector disposed on at least a portion of a second end of the cord body, and a retractable cord unit connected to the cord unit connector to connect the cord body to a harness of a pet.

The wrist connector may adjust in size in response to threading the cord body therethrough in a first direction or a second direction.

The cord unit connector may be integrated into the retractable cord unit.

The retractable cord unit may include a handle body to facilitate gripping thereof, and a retractable cord movably disposed within at least a portion of the handle body to move from retracted within the handle body in a first position to at least partially extracted out of the handle body in a second position, and move from extracted out of the handle body in the second position to retracted within the handle body in the first position.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a perspective view of a hands-free leash, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Hands-Free Leash 100

Wrist Connecting Cord 110

Cord Body 111

Wrist Connector 112

Cord Unit Connector 113

Retractable Cord Unit 120

Handle Body 121

Retractable Cord 122

Button 123

Harness Connector 124

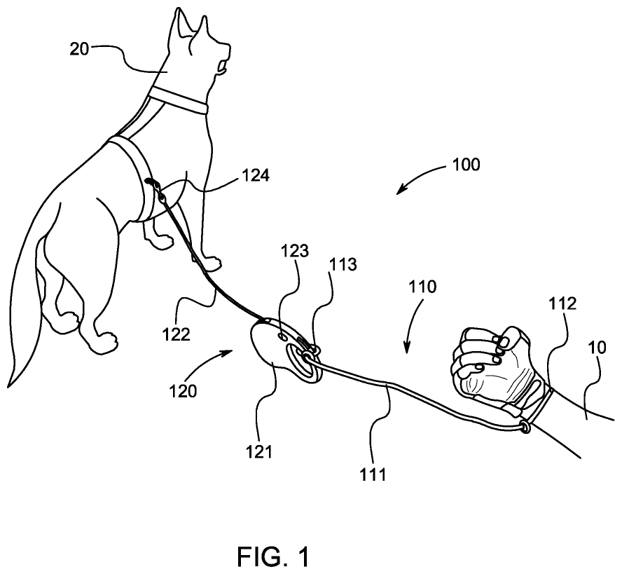

FIG. 1 illustrates a perspective view of a hands-free leash 100, according to an exemplary embodiment of the present general inventive concept.

The hands-free leash 100 may be constructed from at least one of metal, plastic, textile, and rubber, etc., but is not limited thereto.

The hands-free leash 100 may include a wrist connecting cord 110 and a retractable cord unit 120, but is not limited thereto.

The wrist connecting cord 110 may include a cord body 111, a wrist connector 112, and a cord unit connector 113, but is not limited thereto.

The cord body 111 may have an elongate shape. Moreover, the cord body 111 may have a predetermined length, such as five feet, ten feet, twenty feet, etc. Alternatively, the cord body 111 may be elastic and/or at least partially deform (e.g., bend, stretch, expand) in response to an application of force (e.g., pushing, pulling) thereto.

The wrist connector 112 may be a loop. The wrist connector 112 may be disposed on at least a portion of a first end of the cord body 111. The wrist connector 112 may adjust in size in response to threading the cord body 111 therethrough in a first direction or a second direction. For example, the wrist connector 112 may increase in size in response to threading the cord body 111 toward the wrist connector 112 in the first direction and decrease in size in response to threading the cord body 111 away from the wrist connector 112 in the second direction opposite to the first direction.

Thus, the wrist connector 112 may be removably connected to at least a portion of a limb 10 of a user, such as a wrist, a hand, a finger, an arm, etc. Thus, the wrist connector 112 may facilitate hands-free connection.

Referring to FIG. 1, the cord unit connector 113 is illustrated to be a loop. However, the cord unit connector 113 may integrated into the retractable cord unit 120. In other words, the cord unit connector 113 may be irremovable from the retractable cord unit 120.

The cord unit connector 113 may be disposed on at least a portion of a second end of the cord body 111. Moreover, the cord unit connector 113 may connect the cord body 111 to the retractable cord unit 120.

The retractable cord unit 120 may include a handle body 121, a retractable cord 122, a button 123, and a harness connector 124, but is not limited thereto.

The handle body 121 may include an aperture, but is not limited thereto.

The handle body 121 may facilitate gripping thereof.

The retractable cord 122 may be movably (i.e., rotatably) disposed at a first end within at least a portion of the handle body 121. The retractable cord 122 may move from retracted within the handle body 121 in a first position to at least partially extracted out of the handle body 121 in a second position. Conversely, the retractable cord 122 may move from extracted out of the handle body 121 in the second position to retracted within the handle body 121 in the first position. Accordingly, the retractable cord 122 may adjust a length thereof to increase and/or decrease a distance away from the handle body 121 in response to an application of force (e.g., pushing, pulling) thereto. However, the retractable cord 122 may remain extracted after being extracted from the handle body 121.

The button 123 may be disposed on at least a portion of the handle body 121. The retractable cord 122 may retract within the handle body 121 in response to depressing the button 123. Furthermore, the button 123 may release the retractable cord 122, such that the retractable cord 122 may be extended and/or move in response to depressing the button 123.

The harness connector 124 may include a hook, a clamp, a clasp, a wire, a twine, a magnet, and/or any combination thereof, but is not limited thereto.

The harness connector 124 may be disposed on at least a portion of a second end of the retractable cord 122. The harness connector 124 may connect to a harness of a pet 20.

Therefore, the hands-free leash 100 may facilitate hands-free walking of the pet 20 without requiring a constant grip by keeping the pet 20 connected to the user. Also, the hands-free leash 100 may allow multi-tasking by the user, such as using a cell phone, swatting away mosquitos, carrying supplies, and/or other human necessities.

The present general inventive concept may include a hands-free leash 100, including a wrist connecting cord 110, including a cord body 111, a wrist connector 112 disposed on at least a portion of a first end of the cord body 111 to removably connect to at least a portion of a limb 10 of a user, and a cord unit connector 113 disposed on at least a portion of a second end of the cord body 111, and a retractable cord unit 120 connected to the cord unit connector 113 to connect the cord body 111 to a harness of a pet 20.

The wrist connector 112 may adjust in size in response to threading the cord body 111 therethrough in a first direction or a second direction.

The cord unit connector 113 may be integrated into the retractable cord unit 120.

The retractable cord unit 120 may include a handle body 121 to facilitate gripping thereof, and a retractable cord 122 movably disposed within at least a portion of the handle body 121 to move from retracted within the handle body 121 in a first position to at least partially extracted out of the handle body 121 in a second position, and move from extracted out of the handle body 121 in the second position to retracted within the handle body 121 in the first position.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A hands-free leash, comprising:
a wrist connecting cord, comprising:
a cord body,
a wrist connector disposed on at least a portion of a first end of the cord body to removably connect to at least a portion of a limb of a user, and
a cord unit connector disposed on at least a portion of a second end of the cord body; and
a retractable cord unit connected to the cord unit connector to connect the cord body to a harness of a pet.

2. The hands-free leash of claim 1, wherein the wrist connector adjusts in size in response to threading the cord body therethrough in a first direction or a second direction.

3. The hands-free leash of claim 1, wherein the cord unit connector is integrated into the retractable cord unit.

4. The hands-free leash of claim 1, wherein the retractable cord unit comprises:
a handle body to facilitate gripping thereof; and
a retractable cord movably disposed within at least a portion of the handle body to move from retracted within the handle body in a first position to at least partially extracted out of the handle body in a second position, and move from extracted out of the handle body in the second position to retracted within the handle body in the first position.
